(19) United States
(12) Patent Application Publication
(10) Pub. No.: US 2006/0000206 A1
(43) Pub. Date: Jan. 5, 2006

(54) Vacuum engine

(76) Inventor: Vernon C. Stoudt, Salinas, CA (US)

Correspondence Address: Ruth Eure, 4795 Edison Avenue, Boulder, CO, 80301, US

(21) Appl. No.: 10/884,243

(22) Filed: Jul. 2, 2004

(51) Int. Cl. F16D 31/02

(52) U.S. Cl. 60/407

(57) ABSTRACT

An air powered engine that includes at least one pair of diametrically opposing cylinders, a piston in, and fluidly dividing into a first space and a second space, each cylinder, a connecting rod pivotally connected to each piston, a crankshaft pivotally receiving each connecting rod, a pair of solenoid valves in fluid communication with the first space and the second space, respectively, of each of the cylinders, an intake manifold in fluid communication with one valve of the pair of solenoid valves of each space for communicating with the ambient, an exhaust manifold in fluid communication with the other valve of the pair of solenoid valves of each space, an oil pump in fluid communication with the exhaust manifold, and an oil reservoir containing the oil pump therein.

### FIELD OF THE INVENTION

The present invention relates to the field of engines, and more particularly to the field of atmospheric and vacuum driven engines.

### BACKGROUND OF THE INVENTION

Engines which are powered by air exist in the art. For example, U.S. Pat. No. 4,370,857 to Miller describes a vehicle which utilizes pressurized air contained in storage tanks for actuating double acting cylinders which in turn transmit a driving force to an axle of the vehicle. The engine of the instant invention is an improvement over the Miller description because no source of compressed air is required to operate the cylinders. In contrast the present invention requires only atmospheric pressure and a vacuum to drive the cylinders.

U.S. Pat. No. 4,596,119 to Johnson describes another compressed air propulsion system for a vehicle. Again, an air compressor is used as the source of power. The present invention, by contrast, requires no source of compressed air.

U.S. Pat. No. 5,515,675 to Bindschatel also describes the use of compressed air and converts a four stroke internal combustion engine into a two-stroke pneumatically powered engine.

### SUMMARY OF THE INVENTION

The present invention provides an air powered engine that includes at least one pair of diametrically opposing cylinders, each having a piston, and dividing into a first space and a second space, each cylinder having a connecting rod pivotally connected to each piston, a crankshaft pivotally receiving each connecting rod, a pair of solenoid valves in fluid communication with the first space and the second space, respectively, of each of the cylinders, and an intake manifold in fluid communication with one valve of the pair of solenoid valves of each space for communicating with the ambient, an exhaust manifold in fluid communication with the other valve of the pair of solenoid valves of each space, an oil pump in fluid communication with the exhaust manifold, and an oil reservoir containing an oil pump therein to lubricate the moving parts of the engine.

It is an object of the present invention to provide an engine wherein the pistons are suspended in the middle of the cylinder with vacuum on both sides of the pistons at different times. By timing the valves as taught herein, atmospheric pressure is induced on one side of the piston, causing it to move to the vacuum side of the cylinder. Pistons are attached to a connecting rod and crankshaft, as is typically found in conventional internal combustion engines. The vacuum is generated by using a roots-type supercharger on the intake side or a large oil pump driven off the crank shaft, again using the intake side of the pump. Solenoid valves are used to open and close the valves. Since little heat is generated, aluminum is a suitable material for use in the present invention. Also, the engine can be started by using conventional starter and flywheel.

### BRIEF DESCRIPTION OF THE DRAWINGS

FIG. 1 is a schematic drawing showing the engine of the present invention.

FIG. 2 is a schematic drawing showing the timing sequence of the engine of the present invention.

FIG. 3 is a schematic drawing showing the engine of the present invention showing the oil reservoir and oil pump.

### DETAILED DESCRIPTION OF THE INVENTION

In operation, the engine is started in a conventional manner by using a starter and flywheel. When the engine has reached sufficient rotational speed (rpm) and has generated sufficient vacuum, it will drive the pistons, thus turning the crankshaft. The rotational speed of the engine in operation is in a range of about 1 rpm to about 5,000 rpm.

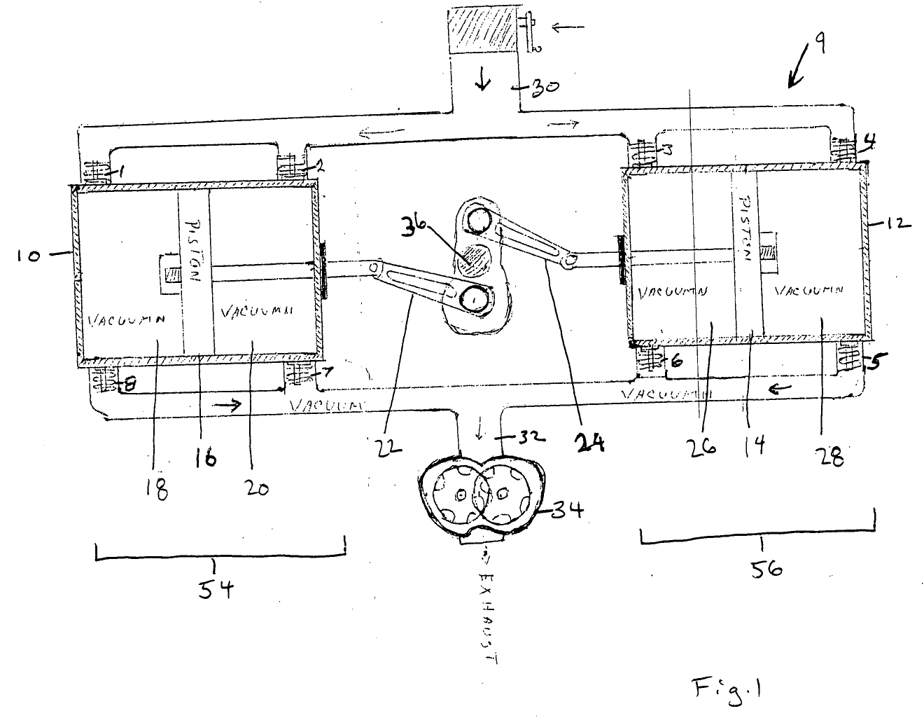

FIG. 1 shows a cylinder engine suitable for use in an automobile having pistons suspended in a vacuum inside the cylinders. By proper timing of the opening and closing of the valves to evacuate one side of the chamber next to the piston and admit atmospheric pressure into the other side of the chamber, it will cause the pistons to move the connecting rods and in turn, rotate the crank shaft.

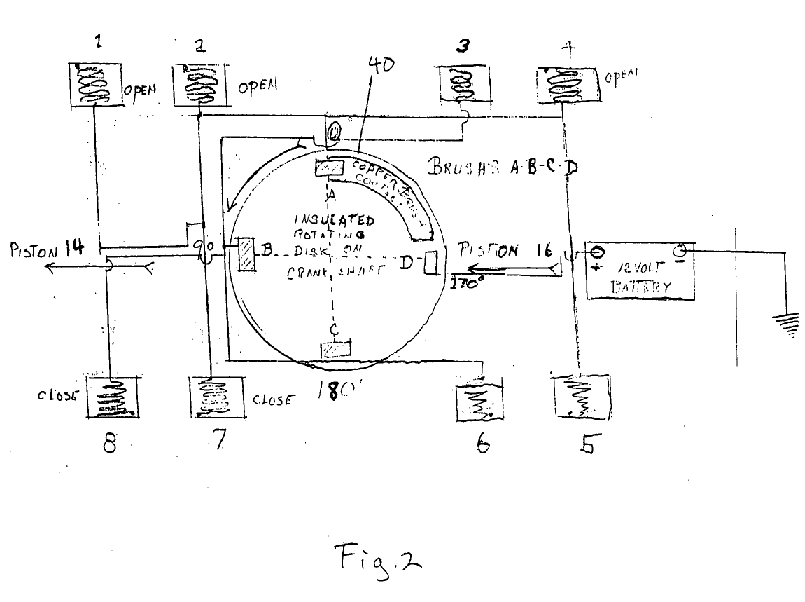

FIG. 2 is a schematic diagram showing one embodiment for timing the opening of the solenoid valves.

For convenience of reading the description, set forth below is a list of the drawing elements:

| | |
|---|---|
| air powered engine | 9 |
| cylinder on side one | 10 |
| cylinder on side two | 12 |
| piston on side two | 14 |
| piston on side one | 16 |
| side one first space | 18 |
| side one second space | 20 |
| side two first space | 28 |
| side two second space | 26 |
| connecting rod cylinder 10 | 22 |
| connecting rod cylinder 12 | 24 |
| solenoid valve side one first space intake | 1 |
| solenoid valve side one second space intake | 2 |
| solenoid valve side two second space intake | 3 |
| solenoid valve side two first space intake | 4 |
| solenoid valve side two second space exhaust | 5 |
| solenoid valve side two first space exhaust | 6 |
| solenoid valve side one second space exhaust | 7 |
| solenoid valve side one first space exhaust | 8 |
| intake manifold | 30 |
| exhaust manifold | 32 |
| supercharger | 34 |
| crankshaft | 36 |
| rotating disk | 40 |
| oil reservoir | 50 |
| oil pump | 52 |
| side one | 54 |
| side two | 56 |

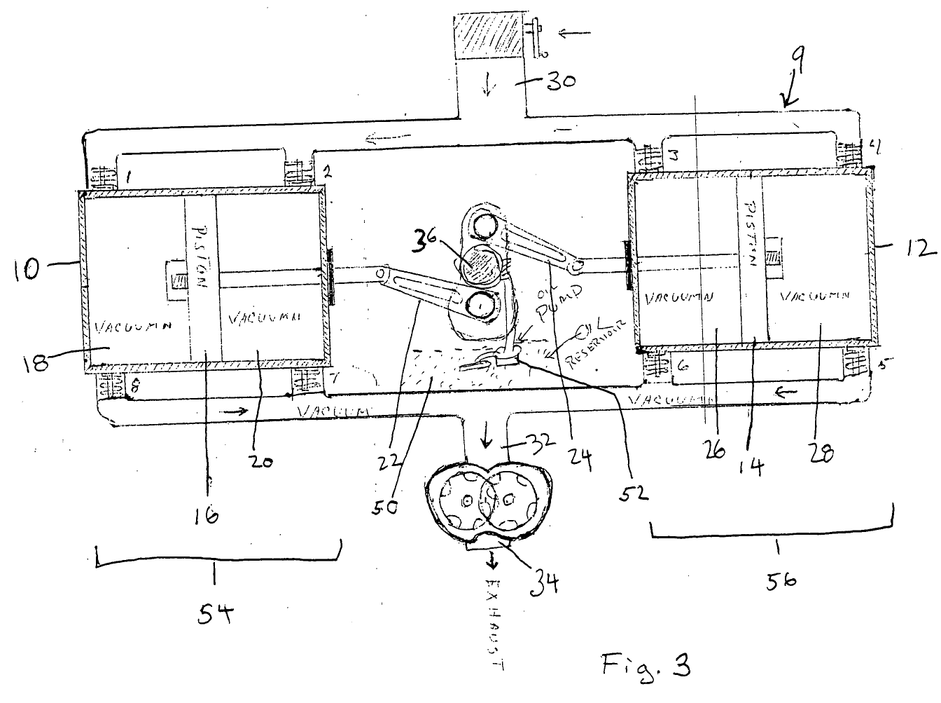

An air powered engine 9 includes a pair of diametrically opposing cylinders 10,12, each having a piston in, 14,16, respectively, and one side 54 (side one) fluidly dividing into a first space 18 and a second space 20, and a second side 56 (side two) fluidly dividing into a first space 28 and a second space 26, each cylinder 10,12 having a connecting rod 22,24 pivotally connected to each piston 14, 16, respectively, a crankshaft 36 pivotally receiving each connecting rod 22, 24, a pair of solenoid valves 1, 8 in fluid communication with the first space 18 and a pair of solenoid valves 2, 7 in fluid communication with the second space 20, respectively, of each of the cylinders 10,12, and intake manifold 30 in fluid communication with valves 1,2,3,4 for communicating with the ambient, an exhaust manifold 32 which is in fluid communication with a roots type supercharger 34 which can be belt driven from the crankshaft 36 at twice crankshaft speed using the vacuum from the intake side to create some additional vacuum and aids in drawing the exhaust air out of the system, or is gear driven. The supercharger 34 can also be gear driven. The supercharger is a large displacement device with rotors inside that will generate 10-20 psi of pressure and at least 26″ of vacuum. They range from 500 cubic inches to 1000 cubic inches, or bigger. One such device is made by Weiand and is available on line at AdvanceAutoParts.com. Another example is made by Powerdyne and is available on line at jcwhitney.com. The exhaust manifold 32 is in fluid communication with the valves 5,6,7,8, and an oil reservoir 50 (shown in FIG. 3) containing the oil pump 52 therein. To start, valves 2, and 4 are open and valves 1 and 3 are closed; valves 6 and 8 are open and 7 and 5 are closed. This drives pistons 16, 14 from left to right. The oil provides lubrication for the moving parts and has no impact on the generation of power.

FIG. 2 shows one timing sequence suitable for use in the engine of the present invention. Valves 1,2,3,4 are normally closed. Open valves 1,2,3,4 to atmospheric pressure, and valves 5,6,7,8 are in fluid contact with vacuum source. Close valves 5,6,7,8 which are normally open. Brushes A,B,C,D, are double brushes which have contacts on each side of rotating insulated disk 40. Rotating insulated disk 40 is on the crankshaft 26 and as the crankshaft 26 rotates the disk 40 rotates. To move pistons 14, 16 to the left, open valves 2 and 4 and close valves 5 and 7. To move pistons 14,16 to the right, open valves 1 and 3 and close valves 6 and 8. When disk 40 is in contact with brushes C and D only one lead wire is required to contact brushes A and B. If the vacuum pump does not evacuate the cylinders at a sufficient rate to evacuate the cylinders between rotations, the timing disk can be gear reduced to a 2 to 1, 3 to 1, or 4 to 1 ratio, as is customary with gasoline engines to admit atmospheric pressure after the cylinders have been evacuated.

The engine block of this engine can be made from any suitable materials, such as aluminum or other machinable metal, for example.

### EXAMPLE 1

In this example, 4 cylinders using 12 inch diameter pistons are used to create a 4″ stroke. This generates 4″×12″×3.146″4=603.19 cubic inches in displacement. Since many engines generate about 1 hp per cubic inch, this engine would generate about 600 hp. Even if the vacuum engine of the present invention generated only half that amount, the output would be 300 hp. Although a 12 inch piston is used, any size piston can be used depending on the output required. Also, there is no practical limit to the number of cylinders which can be used.

### EXAMPLE 2

In this example, 8 cylinders using 12 inch diameter pistons are used to create a 4″ stroke. This generates 4″×12″×3.146×8=1206.4 cubic inches in displacement. Since many engines generate about 1 hp per cubic inch, this engine could generate about 600-1200 hp. Although a 12 inch piston is used, any size piston can be used depending on the output required.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An air powered engine including:
a) at least one pair of diametrically opposing cylinders,
b) at least one pair of pistons which travel inside said cylinders,
c) a block which is divided into a plurality of spaces forming a first space and a second space;
d) at least one pair of connecting rods, each connecting rod having a first end and a second end pivotally connected to each piston at the first end of the connecting rod;
e) a crankshaft pivotally receiving the second end of each connecting rod;
f) at least one pair of solenoid valves comprising a first solenoid valve and a second solenoid valve in fluid communication with the first space and the second space, respectively, of each of the cylinders, and
h) intake manifold in fluid communication with the first valve of the pair of solenoid valves of each space for communicating with the ambient, and
i) exhaust manifold in fluid communication with the second valve of the pair of solenoid valves of each space.

2. The engine of claim 1 further including:
i) an oil pump in fluid communication with the exhaust manifold, and
j) an oil reservoir containing the oil pump therein.

3. The engine of claim 1 further including the first solenoid valve in fluid communication with the first space is opened to admit atmospheric pressure into the first space and the second solenoid valve is closed, and the second space is evacuated, causing the piston to move from the first space to the second space, and further causing the crankshaft to rotate.

4. The engine of claim 3 wherein the second space is evacuated by means of a gear-driven supercharger.

5. The engine of claim 3 wherein the second space is evacuated by means of an oil pump.

6. The engine of claim 3 having two or more pairs of cylinders.

7. The engine of claim 3 further having an insulated rotating disk coaxially mounted on the crankshaft.

8. The engine of claim 7 wherein the rotating disk contacts a plurality of conductive brushes as the disk rotates.

9. The engine of claim 8 wherein the plurality of conductive brushes is four.

10. The engine of claim 8 wherein the conductive brushes are copper.

11. The engine of claim 9 wherein the conductive brushes are copper.

12. The engine of claim 8 wherein the plurality of conductive brushes is more than four.

13. The engine of claim 8 wherein the plurality of conductive brushes is less than four.

14. the engine of claim 3 wherein the block is made of aluminum.

15. The engine of claim 1 wherein the block is made of aluminum.
